(19) United States
(12) Patent Application Publication
(10) Pub. No.: US 2010/0027621 A1
(43) Pub. Date: Feb. 4, 2010

(54) APPARATUS, METHOD AND COMPUTER PROGRAM PRODUCT FOR MOVING IMAGE GENERATION

(75) Inventor: Katsuhisa YANO, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/398,722

(22) Filed: Mar. 5, 2009

(30) Foreign Application Priority Data
Jul. 31, 2008 (JP) 2008-198606

(51) Int. Cl. H04N 7/26; H04N 7/32

(52) U.S. Cl. 375/240.03; 375/240.01; 375/240.16; 375/E07.123; 375/E07.14

(57) ABSTRACT

According to one embodiment, a moving image generating apparatus includes a decoder, a calculator, a first encoder, and a second encoder. The decoder decodes encoded moving image data to obtain decoded moving image data. The calculator calculates an encode parameter used to encode the decoded moving image data. The first encoder encodes the decoded moving image data in a first encoding mode using the encode parameter obtained by the calculator. The second encoder encodes the decoded moving image data in a second encoding mode using the encode parameter obtained by the calculator. The first encoder and the second encoder encode the same decoded moving image data using an identical encode parameter obtained by the calculator.

### CROSS-REFERENCE TO RELATED APPLICATIONS

This application is based upon and claims the benefit of priority from Japanese Patent Application No. 2008-198606, filed Jul. 31, 2008, the entire contents of which are incorporated herein by reference.

### BACKGROUND

1. Field

One embodiment of the invention relates to a technology for generating a plurality of sets of moving image data.

2. Description of the Related Art

HDD recorders have been increasingly used instead of video cassette recorders to record a broadcast television program.

With the HDD recorder, a television program can be stored in a storage medium, such as HDD or magnetooptic disk, as video data in a digital format, for example, H.264. In this case, the capacity of the storage medium occupied by the video data varies depending on the bit rate irrespective of the time taken to record the video data.

Therefore, if a user selects a suitable bit rate, high image quality can be achieved with less storage capacity. In addition, in the HDD recorder, recorded video data can be transcoded to a different bit rate to save the capacity of the HDD, to generate video data to be reproduced on a portable video recorder, or the like.

For example, Japanese Patent Application Publication (KOKAI) No. 2007-158944 discloses a conventional technology for transcoding video data to a different bit rate. Through the conventional technology, a user can use video data at a desired bit rate. On the other hand, transcoding of video data requires almost the same time as recording of the video data.

Besides, even at the same bit rate, image quality of video data may vary depending on the source. For example, when encoded or transcoded at a predetermined bit rate, video content that has less motion provides a relatively high image quality, while one having a large motion may have degradation of the image quality. That is, even if a user sets a suitable bit rate, it is sometimes the case that desired image quality is not achieved.

In general HDD recorders, video data is transcoded at only one bit rate. If video data once transcoded fails to provide a desired image quality, it needs to be transcoded again at a different bit rate. This, again, requires about the same time as recording of the video data.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a moving image generating apparatus according to an embodiment of the invention;

FIG. 2 is an exemplary schematic diagram for explaining common preprocessing performed by the moving image generating apparatus in the embodiment;

FIG. 3 is an exemplary schematic diagram of an index of a frame stored in an image-quality change position storage module with respect to each bit-rate stream in the embodiment;

FIG. 4 is an exemplary schematic diagram of frames of a plurality of bit-rate streams in the embodiment;

FIG. 5 is an exemplary sequence diagram of the overall processing procedures of the moving image generating apparatus in the embodiment; and

FIG. 6 is an exemplary schematic diagram of a hardware configuration of the moving image generating apparatus in the embodiment.

### DETAILED DESCRIPTION

Various embodiments according to the invention will be described hereinafter with reference to the accompanying drawings. In general, according to one embodiment of the invention, a moving image generating apparatus comprises: a decoder configured to decode encoded moving image data to obtain decoded moving image data; a calculator configured to calculate an encode parameter used to encode the decoded moving image data; a first encoder configured to encode the decoded moving image data in a first encoding mode using the encode parameter obtained by the calculator; and a second encoder configured to encode the decoded moving image data in a second encoding mode using the encode parameter obtained by the calculator. The first encoder and the second encoder are configured to encode same decoded moving image data using an identical encode parameter obtained by the calculator.

According to another embodiment of the invention, a moving image generating method comprises: decoding encoded moving image data to obtain decoded moving image data; calculating an encode parameter used to encode the decoded moving image data; first encoding the decoded moving image data in a first encoding mode based on the encode parameter; and second encoding the decoded moving image data in a second encoding mode based on the encode parameter. At the first encoding and the second encoding, the same decoded moving image data are encoded base on an identical encode parameter.

According to still another embodiment, a computer program product implements the above method on a computer.

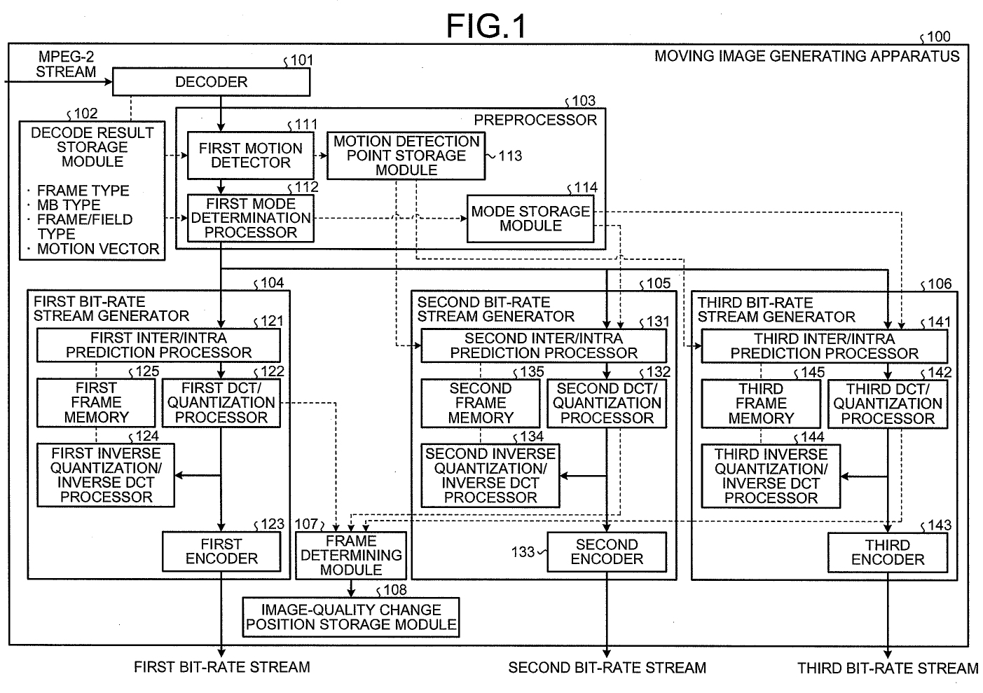

A moving image generating apparatus 100 according to an embodiment of the present invention will be described with reference to FIG. 1. As illustrated in FIG. 1, the moving image generating apparatus 100 comprises a decoder 101, a decode result storage module 102, a preprocessor 103, a first bit-rate stream generator 104, a second bit-rate stream generator 105, a third bit-rate stream generator 106, a frame determining module 107, and an image-quality change position storage module 108.

The moving image generating apparatus 100 of the embodiment generates, having received MPEG-2 streams, a plurality of types of H. 264 streams from the MPEG-2 streams. The H. 264 streams thus generated are stored in a moving image storage module located outside the moving image generating apparatus 100.

It is herein assumed that the MPEG-2 streams input to the moving image generating apparatus 100 are extracted in advance from multiplexed broadcast streams.

The following description also assumes that a user specifies a plurality of recording modes, i.e., three recording modes A, B and C, on the moving image generating apparatus 100 that simultaneously converts broadcast MPEG-2 streams into H. 264 streams. In the recording mode A, encoding is performed at a first bit rate (first encoding mode). In the recording mode B, encoding is performed at a second bit rate (second encoding mode). In the recording mode C, encoding is performed at a third bit rate (third encoding mode).

In the recording modes A, B and C, settings other than the bit rate may be changed. That is, the moving image generating apparatus 100 described herein is only required to generate a plurality of types of streams according to the recording modes set thereto.

The decoder 101 analyzes and decodes MPEG-2 streams input thereto, and stores, in the decode result storage module 102, information such as frame type, macroblock (MB) type, frame/field type, and motion vector.

The decode result storage module 102 may be a memory, and stores the information such as frame type, MB type, frame/field type, and motion vector.

The frame type refers to information for identifying the type of each frame of moving image data (video data). The MB type refers to information for identifying a macro block in a frame.

The frame/field type refers to information for identifying the type of frame/field. The motion vector represents the motion of a predetermined block as a vector over a plurality of frames.

The preprocessor 103 comprises a first motion detector 111, a first mode determination processor 112, a motion detection point storage module 113, and a mode storage module 114.

The preprocessor 103 of the embodiment calculates encode parameters to be set upon generation of streams based on the information obtained when the MPEG-2 streams are decoded. The preprocessor 103 performs mode determination process and motion detection process to perform encoding at the first bit rate as a reference (first recoding mode). The preprocessor 103 calculates, based on these processes, the encode parameters such as the motion vector of each block in a frame, and mode determination results (MB type, block form, etc.). That is, the preprocessor 103 functions as a calculator that calculates the encode parameters. Although motion vector and mode determination results (MB type, block form, etc.) are cited above as examples of the encode parameters, the encode parameters are not limited to them. Any information that can be applicable in common to a plurality of bit rates can be used as an encode parameter.

If results of the motion detection process and the mode determination process performed by the preprocessor 103 are used to generate (encode) streams at other bit rates (second and third bit rates), then it means that the processes are applicable in common to, i.e., the process can be shared among, a plurality of bit rates.

The first motion detector 111 reduces or narrows down detection points to perform the motion detection process based on the motion vector extracted from the streams decoded by the decoder 101. The first motion detector 111 performs the motion detection process on narrowed-down detection points to determine an optimum motion vector. The first motion detector 111 stores, in the motion detection point storage module 113, a detection point where the motion vector is determined together with the motion vector.

The motion detection point storage module 113 stores the motion vector and the detection point where the motion vector is determined by the first motion detector 111. The stored motion vector is used by the second bit-rate stream generator 105 and the third bit-rate stream generator 106.

The first mode determination processor 112 determines an MB type, a block form, a frame/field type, etc. for use in encoding based on the information such as MB type, block form, and frame/field type extracted through decoding.

The MB type identifies whether a macroblock is an intrablock or an interblock. The intrablock refers to a block that does not require motion prediction between frames based on a motion vector. On the other hand, the interblock refers to a block that requires motion prediction between frames based on a motion vector.

Although only one type of block form has been used so far, there are now available a total of seven block forms for motion prediction in H. 264 format, such as 16×16, 16×8, 8×16, and 8×8, to realize high compression efficiency.

The use of the MB type, the block form of the motion vector, etc. specified by the first mode determination processor 112 in common for a plurality of bit rates reduces the processing time and load compared to the case where transcoding is performed a plurality of times.

The first mode determination processor 112 stores the MB type, the block form, the frame/field type, etc. used for encoding in the mode storage module 114.

The mode storage module 114 stores the MB type, the block form, the frame/field type, etc. for use in encoding determined by the first mode determination processor 112. The stored information is used by the second bit-rate stream generator 105 and the third bit-rate stream generator 106.

As described above, in the moving image generating apparatus 100 of the embodiment, the first motion detector 111 performs the process of determining the motion vector (including the detection point for the motion vector), and the first mode determination processor 112 performs the mode determination process. These processes are performed so that the first bit-rate stream generator 104 can generate first bit-rate streams. The motion detection point storage module 113 stores the motion vector and the detection point determined by the first motion detector 111. The mode storage module 114 stores mode determination results obtained by the first mode determination processor 112. The second bit-rate stream generator 105 and the third bit-rate stream generator 106 retrieve the stored information and use them. Thus, the motion vector and the mode determination results can be shared to generate a plurality of types of bit-rate streams.

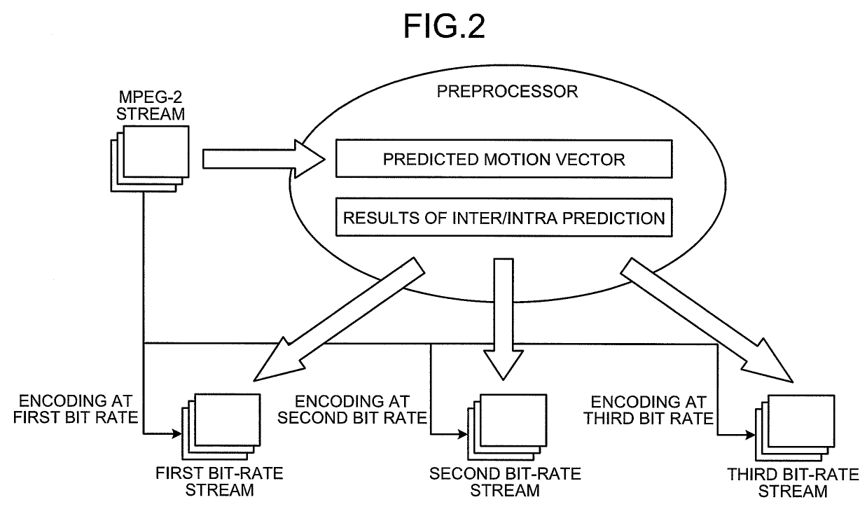

That is, as illustrated in FIG. 2, the motion vector and results of inter/intra prediction obtained through the process performed on the MPEG-2 streams by the preprocessor 103 can be used in common for encoding of streams at the first to third bit rates.

In other words, according to the embodiment, after the motion detection process and the mode determination process, the process is performed with respect to each bit rate (each recording mode); however, decoding, the motion detection process and the mode determination process, which contribute to a large part of the load of encoding, are shared among a plurality of bit rates. This results in less processing time and load compared to the case where encoding is performed with respect to each of a plurality of bit rates.

The first bit-rate stream generator 104 comprises a first inter/intra prediction processor 121, a first DCT/quantization processor 122, a first encoder 123, a first inverse quantization/inverse DCT processor 124, and a first frame memory 125. The first bit-rate stream generator 104 generates first bit-rate streams by using the encode parameters (e.g., motion vector, MB type, and block form) calculated by the preprocessor 103.

The first inter/intra prediction processor 121 performs inter prediction or intra prediction corresponding to the first bit rate based on determination results received with decoded streams, such as the motion vector, and the MB type and the block form determined by the first mode determination processor 112.

The first DCT/quantization processor 122 performs the discrete cosine transform (DCT) for a predetermined block of the decoded streams. Thereafter, the first DCT/quantization processor 122 performs quantization (including the calculation of a quantization parameter and derivation of quantization based on the quantization parameter). The first DCT/quantization processor 122 outputs the quantization parameter obtained by the quantization to the frame determining module 107.

The first encoder 123 generates H. 264 streams based on information (the quantization derived from the quantization parameter) received from the first DCT/quantization processor 122. The first inverse quantization/inverse DCT processor 124 performs inverse quantization and inverse DCT, and updates a reference image on the first frame memory 125.

The first frame memory 125 stores the reference image. The stored reference image is used for the prediction process performed by the first inter/intra prediction processor 121.

The second bit-rate stream generator 105 comprises a second inter/intra prediction processor 131, a second DCT/quantization processor 132, a second encoder 133, a second inverse quantization/inverse DCT processor 134, and a second frame memory 135. The second bit-rate stream generator 105 generates second bit-rate streams by using the encode parameters (e.g., motion vector, MB type, and block form) calculated by the preprocessor 103.

Having received decoded streams from the first mode determination processor 112, the second inter/intra prediction processor 131 performs inter prediction or intra prediction corresponding to the second bit rate. The second inter/intra prediction processor 131 performs the prediction process based on the motion vector (the detection point for the motion vector and the block form of the motion vector) obtained form the motion detection point storage module 113 and the mode storage module 114, and the determination result of the MB type.

The second DCT/quantization processor 132, the second encoder 133, the second inverse quantization/inverse DCT processor 134, and the second frame memory 135 operate in the same manner as the first DCT/quantization processor 122, the first encoder 123, the first inverse quantization/inverse DCT processor 124, and the first frame memory 125, except that they performs the process corresponding to the second bit rate instead of the first bit rate. Therefore their description will not be repeated.

The third bit-rate stream generator 106 comprises a third inter/intra prediction processor 141, a third DCT/quantization processor 142, a third encoder 143, a third inverse quantization/inverse DCT processor 144, and a third frame memory 145. The third bit-rate stream generator 106 generates third bit-rate streams by using the encode parameters (e.g., motion vector, MB type, and block form) calculated by the preprocessor 103.

Having received decoded streams from the first mode determination processor 112, the third inter/intra prediction processor 141 performs inter prediction or intra prediction corresponding to the third bit rate. The third inter/intra prediction processor 141 performs the prediction process based on the motion vector (the detection point for the motion vector and the block form of the motion vector) obtained form the motion detection point storage module 113 and the mode storage module 114, and the determination result of the MB type.

The third DCT/quantization processor 142, the third encoder 143, the third inverse quantization/inverse DCT processor 144, and the third frame memory 145 operate in the same manner as the first DCT/quantization processor 122, the first encoder 123, the first inverse quantization/inverse DCT processor 124, and the first frame memory 125, except that they performs the process corresponding to the third bit rate instead of the first bit rate. Therefore their description will not be repeated.

As described above, in the moving image generating apparatus 100 of the embodiment, the first to third bit-rate stream generators 104, 105 and 106 uses the same encode parameters in common to generate streams at their respective bit rates.

The frame determining module 107 determines a frame in which image quality has changed based on the quantization parameter input thereto. Such a frame, in which image quality has changed, may be determined by any method including known ones. The frame determining module 107 of the embodiment stores a quantization parameter received with respect to each macroblock from the first to third DCT/quantization processors 122, 132 and 142, and calculates statistical data related to the quantization parameter for each frame.

The frame determining module 107 determines a frame in which image quality has changed based on the statistical data. This determination as to a frame, in which image quality has changed, may be made based on a comparison between the statistical data of frames with different bit rates. Alternatively, image quality may be determined to have changed when the average of quantization parameters exceeds a predetermined threshold based on the statistical data.

The frame determining module 107 creates an index of a frame whose image quality is determined to have changed, and stores the index in the image-quality change position storage module 108.

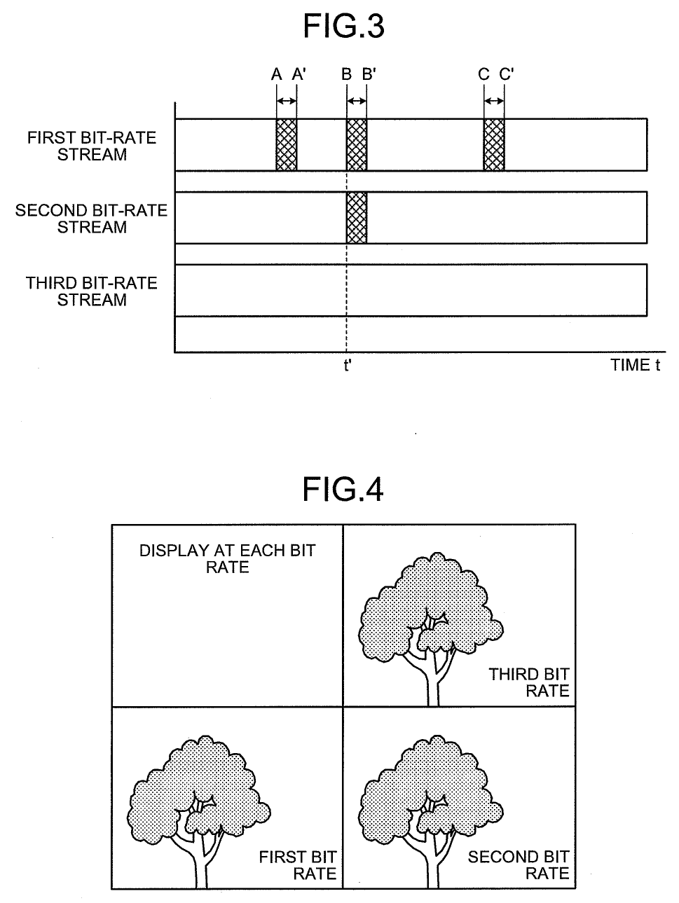

The image-quality change position storage module 108 stores an index of a frame (the position of the frame in which image quality has changed) with respect to each of streams at different bit rates. In the example of FIG. 3, indices indicates that image quality has changed in frames of sections A-A′, B-B′ and C-C′ of a first bit-rate stream. Besides, an index indicates that image quality has changed in a frame of the section B-B′ of a second bit-rate stream. Meanwhile, it is indicated that no frame is detected in which image quality has changed in a third bit-rate stream.

The moving image generating apparatus 100 is capable of displaying, on a display module (not shown), a frame of a section (A-A′, B-B′, C-C′) of any bit-rate stream in which image quality has changed indicated by an index stored in the image-quality change position storage module 108 with a frame of the corresponding section of other bit-rate streams.

For example, if a user select a mode for comparing image quality among generated streams on the moving image generating apparatus 100, a list is displayed of indices of frames stored for respective streams in the image-quality change position storage module 108. The image illustrated in FIG. 3 may be displayed as the list. When the user selects a position with an index of a frame, different bit streams corresponding to the position are simultaneously reproduced.

FIG. 4 is an example of screen display on the display module, in which frames from time t′ in FIG. 3 are displayed for respective bit rates. With reference to the bit-rate streams, the user can replace only a frame of a reference bit-rate stream, in which image quality has degraded, with a corresponding frame of another bit-rate stream, in which image quality remains intact. Further, the user can select a bit-rate stream to store from a plurality of bit-rate streams after actually viewing images to check the image quality. Thus, the user can effectively utilize a plurality of generated bit-rate streams upon checking their image quality.

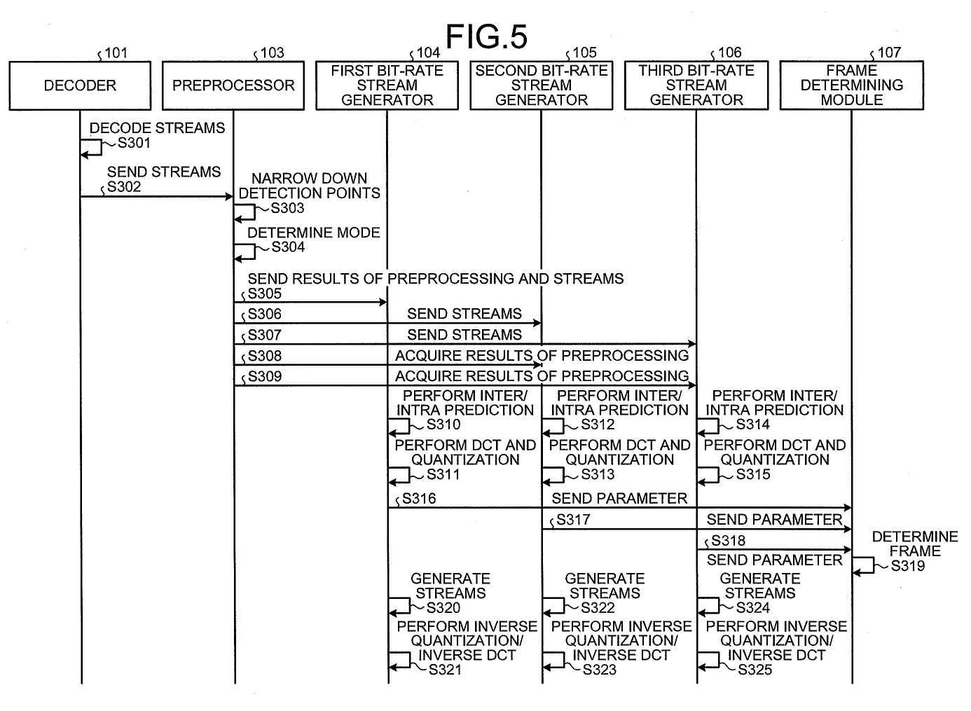

In the following, a description will be given of the overall processing procedures of the moving image generating apparatus 100 with reference to FIG. 5.

First, the decoder 101 decodes MPEG-2 streams (S301), and sends the decoded streams to the preprocessor 103 (S302).

The first motion detector 111 of the preprocessor 103 narrows down detection points to perform the motion detection process based on information on a motion vector extracted from the streams (S303). Among narrowed-down detection points, one where an optimum motion vector is determined is stored in the motion detection point storage module 113.

The first mode determination processor 112 of the preprocessor 103 performs the mode determination process (S304). More specifically, the first mode determination processor 112 determines an MB type, a block form, a frame/field type, etc. used for encoding.

The preprocessor 103 sends the detection point stored in the motion detection point storage module 113, determination results of the first mode determination processor 112, and the decoded streams to the first inter/intra prediction processor 121 of the first bit-rate stream generator 104 (S305).

The preprocessor 103 also sends the decoded streams to the second inter/intra prediction processor 131 of the second bit-rate stream generator 105 (S306), and the third inter/intra prediction processor 141 of the third bit-rate stream generator 106 (S307).

Having received the decoded streams, the second inter/intra prediction processor 131 acquires the detection point from the motion detection point storage module 113, and the mode determination results from the mode storage module 114 (S308). Similarly, having received the decoded streams, the third inter/intra prediction processor 141 acquires the detection point from the motion detection point storage module 113, and the mode determination results from the mode storage module 114 (S309).

Meanwhile, after the process of S305, the first inter/intra prediction processor 121 performs inter prediction or intra prediction corresponding to the first bit rate based on the various types of determination results received with the decoded streams (S310). Thereafter, the first DCT/quantization processor 122 performs DCT and quantization (S311), and sends a quantization parameter to the frame determining module 107 (S316).

After the process of S308, the second inter/intra prediction processor 131 performs inter prediction or intra prediction corresponding to the second bit rate based on the various types of acquired determination results (S312). Thereafter, the second DCT/quantization processor 132 performs DCT and quantization (S313), and sends a quantization parameter to the frame determining module 107 (S317).

After the process of S309, the third inter/intra prediction processor 141 performs inter prediction or intra prediction corresponding to the third bit rate based on the various types of acquired determination results (S314). Thereafter, the third DCT/quantization processor 142 performs DCT and quantization (S315), and sends a quantization parameter to the frame determining module 107 (S318).

The frame determining module 107 calculates statistical data for each frame based on the quantization parameter received with respect to each macroblock of each bit-rate stream. The frame determining module 107 determines a frame in which image quality has changed based on the statistical data (S319). The determination result is stored in the image-quality change position storage module 108.

After the quantization parameter is sent to the frame determining module 107 at S316, the first encoder 123 of the first bit-rate stream generator 104 generates H. 264 streams at the first bit rate (S320). Subsequently, The first inverse quantization/inverse DCT processor 124 performs inverse quantization and inverse DCT, and updates a reference image on the first frame memory 125 (S321). The update reference image is used in later inter prediction/intra prediction.

After the quantization parameter is sent to the frame determining module 107 at S317, the second encoder 133 of the second bit-rate stream generator 105 generates H. 264 streams at the second bit rate (S322). Subsequently, The second inverse quantization/inverse DCT processor 134 performs inverse quantization and inverse DCT, and updates a reference image on the second frame memory 135 (S323).

After the quantization parameter is sent to the frame determining module 107 at S318, the third encoder 143 of the third bit-rate stream generator 106 generates H. 264 streams at the third bit rate (S324). Subsequently, the third inverse quantization/inverse DCT processor 144 performs inverse quantization and inverse DCT, and updates a reference image on the third frame memory 145 (S325).

With the processing procedures described above, a plurality of bit-rate streams are generated, and the image-quality change position storage module 108 stores the position of a frame of each bit-rate stream in which image quality has changed.

In the moving image generating apparatus 100 of the embodiment, the motion detection process and the mode determination process, which contribute to a large part of processing load, are shared among a plurality of bit rates, resulting in less processing time and load.

While the moving image generating apparatus 100 of the embodiment is described above as generating three types of streams, this number is intended by way of example, and not by way of limitation. That is, the moving image generating apparatus 100 may generate two types or more than three types of streams.

Besides, while the moving image generating apparatus 100 is described above as applied to H. 264 video data, it may be applied to video data in other formats.

As described above, according to the embodiment, to generate a plurality of streams in parallel, the motion detection process and the mode determination process are applied in common to and reused for the generation of the streams. This eliminates the need to perform the motion detection process for each bit rate. Thus, the processing time and load for transcoding can be reduced.

The image-quality change position storage module 108 stores an index that specifies the position of a frame in which image quality has changed with respect to each bit-rate stream. With this, the user can easily check whether a desired image quality is maintained in each bit-rate stream. Moreover, the display module displays a frame in which image quality has changed with corresponding frames of other streams. This allows the user to select a bit-rate stream according to his/her preference.

Incidentally, all or part of each bit-rate stream generated by the moving image generating apparatus 100 may be stored in a storage module (not shown) as a copy.

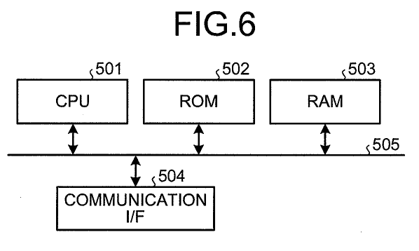

A computer program (hereinafter, “moving image generating program”) may be executed on a commonly used computer to realize the same function as the moving image generating apparatus 100 of the embodiment. As illustrated in FIG. 6, a hardware configuration of such a computer comprises a CPU 501, a read only memory (ROM) 502, a random access memory (RAM) 503, and a communication interface (I/F) 504, which are connected through a bus 505.

The CPU 501 can be of any type but is preferably a multicore CPU. With a multicore CPU, streams at different bit rates can be generated in parallel on the individual cores of the multicore processor, and thus effective processing can be achieved. Nevertheless, a single-core processor can be used as well to implement the above process.

The moving image generating program may be provided as an installable or executable file stored in a computer-readable storage medium such as CD-ROM, flexible disk (FD), CD-R, and digital versatile disk (DVD).

The moving image generating program may be stored in a computer connected via a network such as the Internet and downloaded therefrom. The moving image generating program may be provided or distributed via a network such as the Internet.

The moving image generating program may be stored in the ROM 502 in advance.

The moving image generating program includes modules that perform the above functions (the decoder, the preprocessor, the bit-rate stream generators, etc.). As hardware, the moving image generating program is loaded from the storage medium exemplified above into the main memory, i.e., the RAM 503 and executed by the CPU 501 to implement the decoder, the preprocessor, the bit-rate stream generators, etc. on the RAM 503.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A moving picture generating apparatus comprising:
a decoder configured to decode encoded moving picture data in order to obtain decoded moving picture data;
a calculator configured to calculate an encoding parameter for encoding the decoded moving picture data;
a first encoder configured to encode the decoded moving picture data in a first encoding mode using the encoding parameter obtained by the calculator; and
a second encoder configured to encode the decoded moving picture data in a second encoding mode using the encoding parameter calculated by the calculator, wherein
the first encoder and the second encoder are configured to encode decoded moving picture data using an identical encoding parameter calculated by the calculator.

2. The moving picture generating apparatus of claim 1, wherein the first encoder and the second encoder are configured to generate moving picture data in the first encoding mode and the second encoding mode, respectively, at different bit rates.

3. The moving picture generating apparatus of claim 2, wherein
the calculator comprises a motion detector configured to detect a motion vector with respect to each of predetermined pixel areas of the decoded moving picture data, and determine an encoding motion vector for encoding, and
the first encoder and the second encoder are configured to perform encoding comprising a prediction with the encoding motion vector as the encode parameter.

4. The moving picture generating apparatus of claim 3, wherein
the calculator further comprises a shape determination module configured to determine block shapes of the encoding motion vector, and
the first encoder and the second encoder are configured to perform the prediction with the block shapes determined by the form determination module.

5. The moving picture generating apparatus of claim 3, wherein
the calculator further comprises a determination module configured to determine whether each of the pixel area is suitable for motion vector prediction between a first frame comprising the pixel area and a second frame, and
the first encoder and the second encoder each configured to perform the prediction with either a motion vector between the first frame and the second frame or a motion vector in the first frame, based on a determination result of the determination module.

6. The moving picture generating apparatus of claim 1, wherein
the first encoder comprises:
a first quantization parameter calculator configured to calculate a first quantization parameter with respect to each of predetermined picture areas of the decoded moving picture data for encoding the decoded moving picture data in the first encoding mode in order to generate first moving picture data;
a first frame detector configured to detect a frame of the first moving picture data comprising picture quality changes with the first quantization parameter; and
a first storage module configured to store information indicative of the frame detected by the first frame detector, and
the second encoder comprises:
a second quantization parameter calculator configured to calculate a second quantization parameter with respect to each of the predetermined picture areas for encoding the decoded moving picture data in the second encoding mode in order to generate second moving picture data;
a second frame detector configured to detect a frame of the second moving picture data comprising picture quality changes with the second quantization parameter; and
a second storage module configured to store information indicative of the frame detected by the second frame detector.

7. The moving picture generating apparatus of claim 6, wherein
the first frame detector is configured to calculate a statistical value of the first quantization parameter for each frame of the first moving picture data, and to detect a change of picture quality based on whether the statistical value is equal to or greater than a threshold, and
the second frame detector is configured to calculate a statistical value of the second quantization parameter for each frame of the second moving picture data, and to detect a change of picture quality based on whether the statistical value is equal to or greater than the threshold.

8. The moving picture generating apparatus of claim 3, wherein the first encoder and the second encoder are configured to generate moving picture data conforming with H. 264 standard at different bit rates.

9. A moving picture generating method comprising:
decoding encoded moving picture data in order to obtain decoded moving picture data;
calculating an encoding parameter for encoding the decoded moving picture data;
first encoding the decoded moving picture data in a first encoding mode based on the encoding parameter; and
second encoding the decoded moving picture data in a second encoding mode based on the encoding parameter, wherein
at the first encoding and the second encoding, decoded moving picture data are encoded base on an identical encode parameter.

10. The moving picture generating method of claim 9, wherein
the first encoding comprises:
calculating a first quantization parameter with respect to each of predetermined picture areas of the decoded moving picture data for encoding the decoded moving picture data in the first encoding mode in order to generate first moving picture data;
detecting a frame of the first moving picture data comprising picture quality changes with the first quantization parameter; and
storing information indicative of the frame of the first moving picture data detected by the detecting, and
the second encoding comprises:
calculating a second quantization parameter with respect to each of the predetermined picture areas for encoding the decoded moving picture data in the second encoding mode in order to generate second moving picture data;
detecting a frame of the second moving picture data comprising picture quality changes with the second quantization parameter; and
storing information indicative of the frame of the second moving picture data detected by the detecting.

11. A computer-readable medium comprising a computer program stored on the computer-readable medium that, when executed by a computer, causes the computer to:
decode encoded moving picture data in order to obtain decoded moving picture data;
calculate an encode parameter for encoding the decoded moving picture data;
encode the decoded moving picture data in a first encoding mode based on the encoding parameter; and
encode the decoded moving picture data in a second encoding mode based on the encoding parameter, wherein
decoded moving picture data are encoded in the first encoding mode and the second encoding mode with an identical encode parameter.

12. The computer-readable medium of claim 11, further configured to:
calculate a first quantization parameter with respect to each of predetermined picture areas of the decoded moving picture data for encoding the decoded moving picture in the first encoding mode in order to generate first moving picture data;
detect a frame of the first moving picture data comprising picture quality changes with the first quantization parameter in the first encoding mode; and
store information indicative of the frame of the first moving picture data detected in the first encoding mode, and further configured to:
calculate a second quantization parameter with respect to each of the predetermined picture areas for encoding the decoded moving picture data in the second encoding mode in order to generate second moving picture data;
detect a frame of the second moving picture data comprising picture quality changes with the second quantization parameter in the second encoding mode; and
store information indicative of the frame of the second moving picture data detected in the second encoding mode.
